(19) United States
(12) Patent Application Publication
(10) Pub. No.: US 2022/0305884 A1
(43) Pub. Date: Sep. 29, 2022

(54) METHOD FOR CLIMATE CONTROL

(71) Applicant: AUDI AG, Ingolstadt (DE)

(72) Inventors: Andreas REITBERGER, Hohenwart (DE); Ralph KIRCHHOFF, Gaimersheim (DE); Bastian SCHMANDT, Altmannstein (DE)

(73) Assignee: AUDI AG, Ingolstadt (DE)

(21) Appl. No.: 17/641,642

(22) PCT Filed: Sep. 15, 2020
(86) PCT No.: PCT/EP2020/075681

§ 371 Date: Mar. 9, 2022

(30) Foreign Application Priority Data
Sep. 24, 2019 (DE) 102019125649.6

(51) Int. Cl. B60H 1/22; B60H 1/00

(52) U.S. Cl. CPC B60H 1/2218; B60H 1/2225; B60H 1/00792; B60H 2001/2237

(57) ABSTRACT

A method for climate control, in which an overall mass flow of air is guided through an auxiliary heater, which has multiple zones. The overall mass flow is divided after flowing through the auxiliary heater into multiple partial mass flows, and an nth partial mass flow respectively flows out of an nth zone. A value of at least one flow parameter of an nth partial mass flow is ascertained, and at least one manipulated variable of a respective nth zone is set in dependence on the value of the at least one flow parameter. Overheating of at least one zone of the auxiliary heater is avoided.

### FIELD

The invention relates to a method for climate control and a climate control device.

### BACKGROUND

A vehicle can have a heater. In the case of a conventional internal combustion engine, engine waste heat is used to heat an interior of the vehicle, in an electric vehicle, an electrical heater is provided.

In contrast to a conventional heater, an electrical heater can become arbitrarily hot without further measures if a sufficient air mass flow is not available to flow through it. This can be the case of a partial mass flow is conducted past the auxiliary heater. It is also conceivable that individual zones of the auxiliary heater which can be controlled separately from one another can have flow through them of different strengths, which is possibly inadequate, due to asymmetrical climate control settings in various zones of a passenger compartment.

An electrical heater can cause an increase of an electrical resistance by way of a temperature increase. Power limiting and in case of fault a reduction of the temperature thus occurs. In addition, there are devices for emergency shutdown, which reduce a heating power step-by-step or completely deactivate the heater in the event of excess temperature. An emergency shutdown causes a transient operation, which results in temperature variations in the interior. Moreover, unnecessary material stresses occur due to high temperature gradients.

Document DE 10 2010 000 990 B4 describes a method for operating a climate control system.

A heat exchanger arrangement for heating air is known from document DE 10 2012 108 886 A1.

An electrical auxiliary heater for a motor vehicle is described in document EP 2 402 209 A1.

### SUMMARY

Against this background, it was an object to effectively operate a climate control device.

The method according to the invention is provided for climate control, i.e., for heating and/or cooling, using an embodiment of the climate control device, wherein an overall mass flow of air flowing in a flow direction is conducted through an electrical auxiliary heater or an electrical auxiliary heating element which has multiple zones, wherein the overall mass flow is divided into multiple partial mass flows after flowing through the auxiliary heater, wherein an nth partial mass flow flows in each case from an nth zone of the auxiliary heater, which results from the overall mass flow, wherein a respective nth partial mass flow flows in a respective flow direction, for example an nth flow direction, after flowing out of the auxiliary heater and/or after flowing through the auxiliary heater. A value of at least one flow parameter of the overall mass flow and/or the resulting partial mass flows is ascertained. In addition, at least one manipulated variable, for example a heating power of a respective nth zone of the auxiliary heater, from which the nth partial mass flow flows and/or through which the nth partial mass flow flows, is set as a function of a value of the at least one flow parameter of the overall mass flow and/or a value of the at least one flow parameter of at least one partial mass flow.

The climate control device has, in addition to the auxiliary heater, a fan for providing the overall mass flow and at least one flap. The fan is arranged in the flow direction before the auxiliary heater and the at least one flap is arranged after it.

In one embodiment, the value of the at least one flow parameter of the nth partial mass flow is calculated and/or simulated and thus ascertained. In this case, it is possible to take into consideration as an input value at least one operating parameter of the fan, for example its torque and/or its speed, at least one operating parameter of the auxiliary heater, and/or at least one operating parameter, for example a respective position, of the at least one flap and to calculate the at least one flow parameter of the nth partial mass flow therefrom. The at least one operating parameter of the auxiliary heater is dependent on a respective zone through which the overall mass flow flows. In consideration of the at least one operating parameter of the fan, at least one flow parameter of the overall mass flow can also be calculated, wherein the at least one flow parameter of the overall mass flow can also be measured and thus detected or acquired.

Furthermore, an absolute value of the at least one flow parameter is calculated and/or simulated by a model from respective values of the at least one flow parameter of all partial mass flows, so that the absolute value of all partial mass flows can be calculated and/or simulated by the model. In the model, an integral measured variable, for example the overall mass flow, is used on the basis of an operation of the fan. In addition, a splitting into partial mass flows due to the position of the at least one flap is taken into consideration and/or performed.

In this case, a respective nth partial mass flow results from a respective nth component of the original overall mass flow which flows through or has flowed through a respective nth zone. The overall mass flow flowing in its flow direction has the value, for example the original value, of the at least one flow parameter which is given before flowing through the auxiliary heater. After flowing through the auxiliary heater, the partial mass flows result from the overall mass flow, wherein an nth partial mass flow flows in its respective, for example nth flow direction and has a value, for example an nth value of the at least one flow parameter. In this case, the nth value of the at least one flow parameter of the nth partial mass flow results from the original value of the at least one flow parameter of the overall mass flow or the respective nth component of the overall mass flow after flowing through the auxiliary heater, wherein the value of the at least one flow parameter is changed by thermal properties of the auxiliary heater, for example of a respective zone of the auxiliary heater, wherein the zones can have different thermal properties. The flow directions of the overall mass flow and the individual partial mass flows are generally oriented in parallel to one another.

The manipulated variable or an operating parameter can be, for example, a temperature and/or the heating power of the respective nth zone from which the respective thermal property results. The auxiliary heaters typically have different temperatures, for example, due to an asymmetrical climate control setting and accordingly they are differently hot or warm or cold or cool depending on the definition. By supervising, i.e., by controlling and/or regulating the heating power and/or temperature of the individual zones, temperature variations or temperature gradients can be avoided inside the climate control device.

In one embodiment, the value of the at least one flow parameter of the overall mass flow is detected or measured by a detector of the climate control device designed as an overall detector, which is arranged in the flow direction of the overall mass flow before the auxiliary heater. Alternatively or additionally, the value of the at least one flow parameter of an nth partial mass flow is detected or measured by an nth partial detector as a detector of the climate control device which is arranged in the flow direction of the nth partial mass flow after the nth auxiliary heating element.

The temperature, a pressure, or a flow speed of the overall mass flow and/or the partial mass flows can be ascertained as flow parameters, i.e., calculated and/or acquired and thus detected.

In addition, the nth partial mass flow is redirected by at least one nth flap, which is arranged in the flow direction of the nth partial mass flow after the nth zone of the auxiliary heating element, wherein a position of the nth flap is controlled, for example controlled and/or regulated, for example set as a function of the ascertained value of the at least one flow parameter of the nth partial mass flow and/or the overall mass flow. A respective flap is designed or is to be referred to as a temperature flap and/or air flap.

The method is provided for the climate control of a vehicle, for example of an interior of a vehicle.

With one embodiment of the method, overheating or an excessively high temperature of at least one zone of the auxiliary heater, thus one zone or multiple zones, is avoided, by which an excess temperature protection is provided for the auxiliary heater. Overheating of the climate control device described hereinafter, which has the auxiliary heater, can thus also be avoided.

The climate control device according to the invention has an auxiliary heater having multiple zones and a control unit, wherein the auxiliary heater is designed for the purpose of dividing an overall mass flow of air which is conducted through the auxiliary heater into multiple partial mass flows after flowing through the auxiliary heater, wherein an nth partial mass flow respectively flows out of an nth zone of the auxiliary heater, wherein the nth partial mass flow results from an nth component of the overall mass flow, wherein the nth component of the overall mass flow flows through the nth zone and flows out of the nth zone as the nth partial mass flow. The control unit is designed for the purpose of ascertaining at least one flow parameter of the overall mass flow and/or the resulting partial mass flows and setting at least one manipulated variable, for example a heating power, of a respective nth zone of the auxiliary heater as a function of the value of the at least one flow parameter of the overall mass flow and/or at least one partial mass flow. For this purpose, the heating power of the respective zone is set by setting an electric current which flows through a respective zone, and/or an electrical voltage which is applied to the respective zone.

The electrical climate control device also has a fan or a ventilator which is designed to generate the overall mass flow of air and conduct it through the zones of the auxiliary heater. The fan is arranged inside the climate control device in the flow direction of the overall mass flow before the auxiliary heater.

In addition, the climate control device has at least one flap, which is arranged in the flow direction of the overall mass flow after the auxiliary heater. The climate control device can also have a climate control unit, which is arranged in the flow direction of the overall mass flow after the auxiliary heater. The flaps, i.e., temperature and/or air flaps, are arranged between the auxiliary heater and the climate control unit.

The climate control unit comprises further components, for example a further fan, a further auxiliary heater, further flaps, and guiding elements to set an air and temperature distribution of the partial mass flows for various vents. The climate control device is typically designed to control the climate of an interior of a vehicle, for example a motor vehicle. Using the climate control unit, each partial mass flow can be guided depending on direction to a respective provided vent, from which it is guided into the interior. A spatial distribution and/or layering of the temperature of the air in the interior is influenced using the climate control unit, for example, so that in different regions of the interior, for example in a foot region or a head region, a temperature provided for this purpose can be set in each case for occupants of the vehicle.

Furthermore, the climate control device optionally has at least one detector or sensor, for example a thermometer, a pressure measuring device, and/or at least one anemometer for measuring a speed of flowing air, which is designed to detect a value of at least one flow parameter of the overall mass flow and/or the resulting partial mass flows. A detector designed as an overall detector is arranged between the fan and the auxiliary heater. Partial detectors as further detectors are arranged in the flow direction of the overall mass flow after the auxiliary heater and before the climate control unit.

In one embodiment of the method presented, individual partial mass flows, which flow through the individual zones and thus through respective subsections of the electrical auxiliary heater and result due to division of the overall mass flow by the auxiliary heater, are ascertained or determined, i.e., calculated and possibly detected. On the basis of values of the at least one flow parameter of the partial mass flows, an operating strategy is carried out for the auxiliary heater by setting the manipulated variables. Furthermore, electrical operating behavior of the fan or ventilator, which has a fan motor or a ventilator motor, respectively, is evaluated, by which the overall mass flow of air or an overall air mass flow by the climate control device or climate control system is determined. The operating behavior of the ventilator is supervised or monitored and evaluated on the basis of manipulated variables of the ventilator and/or on the basis of the overall mass flow generated thereby, which is detected by the overall detector.

In one embodiment, flaps, i.e., positions of the flaps, and further manipulated variables in the climate control unit and in the vents of the climate control device are checked and/or monitored on the basis of the partial mass flows of air resulting from the overall mass flow. The original overall mass flow of air can be divided or split, for example, by two zones of the electrical auxiliary heater, for example into two partial mass flows, i.e., a first partial mass flow which results from a first component of the overall mass flow and a second partial mass flow which results from a second component of the overall mass flow, wherein one partial mass flow can also be formed and/or designated, for example, as a bypass mass flow. It is possible here to calculate an amount of both partial mass flows by way of the model. In dependence on at least one partial mass flow, typically all partial mass flows, a heating power of the electrical auxiliary heater is supervised and thus controlled and/or regulated, wherein, inter alia, overheating of the climate control device can be avoided.

Furthermore, it is possible by monitoring flaps for the different zones or climate zones of the auxiliary heater and by monitoring further manipulated variables in the climate control unit and the vents to divide the overall mass flow of air into various partial mass flows which flow out of various zones and/or through various zones of the electrical auxiliary heater. The respective amount of all partial mass flows can be calculated by the model. The heating power of the auxiliary heater is checked in dependence on the at least one partial mass flow, in general all partial mass flows, wherein it is possible to supervise manipulated variables, for example a heating power, of the individual zones independently of one another and to avoid overheating of the climate control device.

Alternatively or additionally, the overall mass flow is split by the auxiliary heater having various zones into various partial mass flows, wherein the individual zones are supervised and thus controlled and/or regulated. At least one zone can be designed and/or designated as a bypass.

It is possible by way of such embodiments of the method to avoid thermal overstress of the climate control device and enable continuously regulated operation for the climate control device, so that an emergency shutdown which is otherwise required can be omitted.

In one embodiment of the method, a model designed as a fan model is used, using which, with the aid of an electrical power and/or speed as a manipulated variable of the fan, for example of the fan motor, the overall mass flow is calculated as the volume flow of the air, wherein this overall mass flow is split by a network model, which in one embodiment comprises and/or describes the zones, into individual partial mass flows of air. It is also possible here to limit an electrical power as a manipulated variable of individual zones or of the entire auxiliary heater in a software-controlled manner or by a software function which is executed by the control unit of the climate control device, wherein a maximum permissible temperature of the auxiliary heater is limited and is thus not exceeded.

Further advantages and embodiments of the invention result from the description and the appended drawings.

It is obvious that the above-mentioned features and the features still to be explained hereinafter are usable not only in the respective specified combination but also in other combinations or alone without leaving the scope of the present invention.

### BRIEF DESCRIPTION OF THE FIGURE

The invention is schematically illustrated on the basis of an embodiment in the drawing and is described schematically and in more detail with reference to the drawing.

FIG. 1 shows a schematic illustration of an embodiment of the climate control device according to the invention.

### DETAILED DESCRIPTION

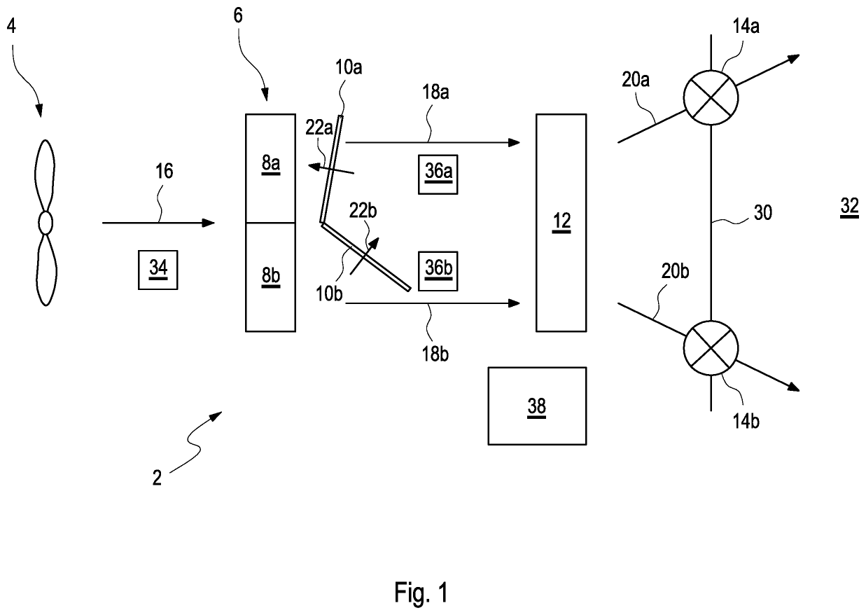

The embodiment of the climate control device 2 schematically shown on the basis of FIG. 1 comprises a fan 4, an electrical auxiliary heater 6 having a first zone 8a and a second zone 8b, a first flap 10a, a second flap 10b, a climate control unit 12, a first vent 14a, and a second vent 14b.

This climate control device 2 is arranged in a housing, which is delimited here by a wall 30, in which the two vents 14a, 14b are located as openings of the climate control device 2 and/or the wall 30 in relation to an environment 32, which is climate controlled, i.e., heated and/or cooled, by the climate control device 2. In one possible embodiment, the climate control device 2 is provided for a vehicle, in particular for an interior of the vehicle, and is designed to control the climate of the interior as the environment 32.

During operation of the climate control device 2, an overall mass flow of air 16 is generated by the fan 4, which is directed onto the electrical auxiliary heater 6 and flows through it. It is provided here that the overall mass flow 16 is divided by the auxiliary heater 6 here into two partial mass flows 18a, 18b, in another embodiment possibly also into more than two partial mass flows. The first partial mass flow 18a result here from a first component of the overall mass flow 16, which has flowed through the first zone 8a. The second partial mass flow 18b results from a second component of the overall mass flow 16, which has flowed through the second zone 8b.

In addition, the climate control device 2 comprises a detector designed as an overall detector 34, which is arranged here between the fan 4 and the auxiliary heater 6 and is designed to acquire a value of at least one flow parameter of the overall mass flow 16, for example its temperature, and thus detect it.

In addition, the climate control device 2 comprises as further detectors a first partial detector 36a and a second partial detector 36b, wherein the first partial detector 36a is arranged here after the first zone 8a and before the climate control unit 12 in the flow direction of the overall mass flow 16 or the first partial mass flow 18a. A second partial detector 36b is arranged in the flow direction of the overall mass flow 16 or the second partial mass flow 18b after the second zone 8b of the auxiliary heater 6 and before the climate control device 12. A respective detector 36a, 36b is designed here to acquire and thus detect a value of at least one flow parameter of a respective partial mass flow 18a, 18b, which flows out of a respective zone 8a, 8b of the auxiliary heater 6. Furthermore, the device 2 has a control unit 38, which is designed to supervise an operation of the climate control device 2 and thus to control and/or regulate it in dependence on at least one detected mass flow, i.e., in dependence on the value of the at least one flow parameter of the at least one mass flow, i.e., of the partial mass flows 18a, 18b and possibly of the overall mass flow 16.

To supervise the climate control device, a manipulated variable is set, for example a heating power or temperature, of at least one zone 8a, 8b of the auxiliary heater and/or a manipulated variable of at least one flap 10a, 10b, for example a position of a respective flap 10a, 10b within a respective partial mass flow 18a, 18b. A respective flap 10a, 10b is designed here or is to be designated as a temperature flap and/or air flap.

The first partial mass flow 18a is guided in the flow direction to the climate control unit 12 in dependence on the position of the first flap 10a, which is connected downstream of the first zone 8a in the flow direction of the overall mass flow 16. Accordingly, the second partial mass flow 18b is guided in dependence on the position of the second flap 10b, which is arranged in the flow direction of the overall mass flow 16 after the second zone 8b, in the flow direction to the climate control unit 12. A possible movement of a respective flap 10a, 10b between two positions is indicated here by arrows 22a, 22b. Furthermore, the first partial mass flow 18a flows through the climate control unit 12 and is guided as the partial mass flow 20a controlled in climate by the climate control device 12 through the first vent 14a into the interior of the vehicle. The second partial mass flow 18b of air also flows through the climate control device 12 and is then guided as the partial mass flow 20b controlled in climate by the climate control unit 12 through the second vent 14b into the interior of the vehicle.

It is provided in one embodiment here that the second zone 8b has a higher temperature than the first zone 8a, wherein the first zone 8a can also be referred to as a bypass zone. Accordingly, the second partial mass flow 18b has a higher temperature than the first partial mass flow 18a. In the scope of one embodiment of the method according to the invention, the second partial mass flow 18b is guided through the second zone 8b, which can also be referred to as a heating zone.

In the second zone 8b, an overtemperature or excessively high temperature can occur if the component of the overall mass flow 16 which flows through the second zone 8b and from which the second partial mass flow 18b results is excessively small.

Due to the difference of the temperatures of the two partial mass flows 18a, 18b, the climate control unit 12 through which the partial mass flows 18a, 18b flow has an inhomogeneous temperature distribution, so that the resulting partial mass flows 20a, 20b also have different temperatures.

In the embodiment of the climate control device 2, it is provided that a model is stored in the control unit 38, using which an amount of the partial mass flows 18a, 18b, i.e., an amount of the at least one flow parameter of the partial mass flows 18a, 18b is calculated from values of the at least one flow parameter of the partial mass flows 18a, 18b, alone or in combination, wherein a respective value of the at least one flow parameter of a respective partial mass flow 18a, 18b is taken into consideration. If it results here that the temperature of the second partial mass flow 18b is excessively high, the heating power of the second zone 8b of the auxiliary heater 6 is reduced.

### LIST OF REFERENCE SIGNS

2 climate control device
4 fan
6 auxiliary heater
8a, 8b zone
10a, 10b flap
12 climate control unit
14a, 14b vent
16 overall mass flow
18a, 18b partial mass flow
20a, 20b partial mass flow
22a, 22b arrow
30 wall
32 environment
34 overall detector
36a, 36b partial detector
38 control unit

1-11. (canceled)

12. A method for climate control, in which an overall mass flow of air is guided through an auxiliary heater, which has multiple zones, wherein the overall mass flow is divided after flowing through the auxiliary heater into multiple partial mass flows, wherein an nth partial mass flow respectively flows out of an nth zone, wherein a value of at least one flow parameter of an nth partial mass flow is ascertained, wherein at least one manipulated variable of a respective nth zone is set in dependence on the value of the at least one flow parameter.

13. The method as claimed in claim 12, wherein the value of the at least one flow parameter of the nth partial mass flow is calculated and/or simulated and thus ascertained.

14. The method as claimed in claim 13, wherein an absolute value of the at least one flow parameter is calculated from values of the at least one flow parameter of all partial mass flows by a model.

15. The method as claimed in claim 12, wherein a value of at least one flow parameter of the overall mass flow, is detected by an overall detector, which is arranged before the auxiliary heater in a flow direction of the overall mass flow, and is thus ascertained, and/or in which the value of the at least one flow parameter of the nth partial mass flow is detected by an nth partial detector, which is arranged in a flow direction of the nth partial mass flow after the nth zone and is thus ascertained.

16. The method as claimed in claim 12, wherein the nth partial mass flow is redirected by at least one nth flap, which is arranged after the nth zone of the auxiliary heater in the flow direction of the nth partial mass flow, wherein a position of the nth flap is set.

17. The method as claimed in claim 12, for the climate control of an interior of a vehicle.

18. The method as claimed in claim 12, wherein overheating of at least one zone of the auxiliary heater is avoided.

19. A climate control device, which has an auxiliary heater having multiple zones and a control unit, in which the auxiliary heater is designed to divide an overall mass flow of air, which is guided through the auxiliary heater, into multiple partial mass flows after flowing through the auxiliary heater, wherein an nth partial mass flow results respectively from an nth zone, wherein the control unit is designed to ascertain a value of at least one flow parameter of an nth partial mass flow and to set at least one manipulated variable of a respective nth zone in dependence on the value of the at least one flow parameter.

20. The climate control device as claimed in claim 19, which has a fan, which is designed to generate the overall mass flow of air and conduct it through the zones of the auxiliary heater.

21. The climate control device as claimed in claim 19, which has at least one flap, which is arranged after the auxiliary heater in the flow direction of the overall mass flow.

22. The climate control device as claimed in claim 19, which has a climate control unit, which is arranged after the auxiliary heater in the flow direction of the overall mass flow.

23. The method as claimed in claim 13, wherein a value of at least one flow parameter of the overall mass flow, is detected by an overall detector, which is arranged before the auxiliary heater in a flow direction of the overall mass flow, and is thus ascertained, and/or in which the value of the at least one flow parameter of the nth partial mass flow is detected by an nth partial detector, which is arranged in a flow direction of the nth partial mass flow after the nth zone and is thus ascertained.

24. The method as claimed in claim 14, wherein a value of at least one flow parameter of the overall mass flow, is detected by an overall detector, which is arranged before the auxiliary heater in a flow direction of the overall mass flow, and is thus ascertained, and/or in which the value of the at least one flow parameter of the nth partial mass flow is detected by an nth partial detector, which is arranged in a flow direction of the nth partial mass flow after the nth zone and is thus ascertained.

25. The method as claimed in claim 13, wherein the nth partial mass flow is redirected by at least one nth flap, which is arranged after the nth zone of the auxiliary heater in the flow direction of the nth partial mass flow, wherein a position of the nth flap is set.

26. The method as claimed in claim 14, wherein the nth partial mass flow is redirected by at least one nth flap, which is arranged after the nth zone of the auxiliary heater in the flow direction of the nth partial mass flow, wherein a position of the nth flap is set.

27. The method as claimed in claim 15, wherein the nth partial mass flow is redirected by at least one nth flap, which is arranged after the nth zone of the auxiliary heater in the flow direction of the nth partial mass flow, wherein a position of the nth flap is set.

28. The method as claimed in claim 13, for the climate control of an interior of a vehicle.

29. The method as claimed in claim 14, for the climate control of an interior of a vehicle.

30. The method as claimed in claim 15, for the climate control of an interior of a vehicle.

31. The method as claimed in claim 16, for the climate control of an interior of a vehicle.
